(19) United States
(12) Patent Application Publication
(10) Pub. No.: US 2014/0249013 A1
(43) Pub. Date: Sep. 4, 2014

(54) CENTRIFUGE APPARATUS

(71) Applicant: DYNAMIC EXTRACTIONS LIMITED, Slough, Berkshire (GB)

(72) Inventor: Philip Wood, Slough (GB)

(73) Assignee: DYNAMIC EXTRACTIONS LIMITED, Slough, Berkshire (GB)

(21) Appl. No.: 14/347,921

(22) PCT Filed: Sep. 28, 2012
(86) PCT No.: PCT/GB2012/052410

§ 371 Date: Mar. 27, 2014

(30) Foreign Application Priority Data
Sep. 28, 2011 (GB) 1116721.0

(51) Int. Cl. B04B 15/00; G01N 30/42

(52) U.S. Cl. CPC B04B 15/00; G01N 30/42
USPC 494/15

(57) ABSTRACT

The invention relates to centrifuge apparatus of a type which is typically, although not necessarily exclusively, for use in counter current chromatography in which substances are caused to partition between two phases in a column typically in the form of a helix or spiral. The apparatus includes leads which connect the inlet and outlet conduits to a column which is moved by the apparatus and in accordance with the invention the leads are constrained within a sheath which includes a lubricant to allow lubrication of the same while the apparatus is in use and thereby increase the longevity of the apparatus. The opposing ends of the leads can also be constrained in terms of movement with, at one end of the leads being fully constrained and the opposing end the leads being constrained in terms of rotational movement.

The present invention relates to centrifuge apparatus of a type which is typically, although not necessarily exclusively, for use in counter current chromatography.

Counter current chromatography (CCC) is a known technique in which substances are caused to partition between two liquid phases in a column in the form of a helix or spiral, which may be arranged as multiple layers. One of the two liquid phases is a static phase and the other liquid phase is a mobile phase. In practice, the static phase is kept static using centrifugal force by rotating the column about a first axis while the column is itself rotated orbitally about a second axis radially distanced from the centre of the column, i.e. in so called “planetary” rotation. Whilst in this planetary motion the mobile phase is caused to flow along the column in contact with the static phase. This two-component rotational motion causes rapidly fluctuating centrifugal forces in the column, resulting in alternating mixing and de-mixing of the static and mobile phases, and consequent partitioning of the substance between the static and mobile phases so that substances in the mobile phase become located at distinct positions in the flow of the mobile phase. Centrifuges for counter current chromatography typically have one or more such columns of substantial length (many metres), and such are rotated at high speeds, typically 800 rpm.

A number of constructions for such columns are known. One construction comprises a helical coil of tubing mounted on a bobbin. In another construction a spiral column is formed between two mating substrates. Most columns are wound as multiple helical layers and an example of such a centrifuge is disclosed in WO-A-2003/006639.

The development of counter current chromatography centrifuges is still, largely, in it's infancy. One of the major factors restricting the use of counter current chromatography as a preparative tool is the lifetime of the components of the centrifuge apparatus under the stresses of rotation. It would be highly desirable to construct a centrifuge apparatus which could be operated for a longer period without maintenance or replacement of parts.

Typically such centrifuges comprise either one such column mounted for rotation and balanced by a counterweight, or two columns mounted diametrically opposite so that they balance each other. A typical arrangement is for example disclosed in WO-A-2003/006639.

In such centrifuges it is necessary to provide liquid flow communication between the rotating columns and stationary liquid input and output means. This communication is normally provided by tubular input and outlet conduits normally called in the art “flying leads”. Typically each flying lead is threaded along the second axis, about which the columns rotate in planetary orbital rotation, and then connects with the column, typically along the first axis about which the column itself rotates. By arranging the flying leads in this way, the respective winding effects of rotation of the flying leads about the first and second rotation axes cancel each other out and the flying leads do not become tangled. A particular problem with present centrifuges is achieving a long lifetime of components, such as the flying leads, between maintenance or replacement intervals. In WO-A-2003/006639 the flying leads are enclosed within a sheath of elastomer material in which the flying leads are embedded.

The flying leads which are typically fitted have a 1.6 mm ( 1/16 inch) outside diameter and an internal diameter (bore) of 0.8 mm ( 1/32 inch) which restricts the maximum flow rate of the mobile phase that can be pumped through the column. The speed of a CCC separation/purification process depends primarily upon the mobile phase flow rate such that the higher the mobile phase flow rate the greater the speed of the separation and hence improving the performance of the CCC apparatus. Thus, generally, in order to increase performance of the CCC apparatus requires the use of larger diameter flying leads.

HPCCC apparatus is characterized by rotation at speeds greater than 800 rpm creating greater centripetal accelerations. In turn this allows the static phase to be retained within the column against significantly higher mobile phase flow rates thus improving the performance of HPCCC instruments. This means that larger scale columns require larger diameter flying leads. However doubling the diameter increases the stiffness of a flying lead by a factor of 16 and it is found that increases in flying lead stiffness and higher centripetal accelerations shorten the service life of flying leads. Conventionally therefore the apparatus is fitted with a means that both feeds the flying lead through the instrument and supports the weight of the flying lead. Conventionally, for each day that the apparatus is used approximately 1 to 2 ml of grease has to be applied to each flying lead assembly to obtain a 120 hour service life for the apparatus and the grease will escape and from the apparatus over time which, in itself, can considerably shorten the life of the apparatus and/or cause contamination problems.

The present invention seeks to address the problem of degradation of flying leads and to provide an improved centrifuge apparatus for counter current chromatography with an improved lifetime. Other objectives and advantages of the present invention will be apparent from the following description.

According to this invention there is provided centrifuge apparatus, comprising a shaft on which at least one column is mounted for planetary rotation about the shaft, the column having an inlet and an outlet connected to respective inlet and outlet leads for communication to respective inlet and outlet conduits, wherein between the column and the inlet and outlet conduits the inlet and/or outlet leads are at least partially located within a tubular sheath having an end adjacent the column and an end adjacent the shaft, the tubular sheath containing a lubricant therein.

Typically the apparatus is for use for counter current chromatography.

In one embodiment the shaft is a cantilever shaft.

Typically the said inlet and outlet conduits follow the shaft.

In one embodiment the inlet and/or outlet leads are substantially enclosed by the sheath.

Typically the sheath is sealed at least at its end adjacent to the column with a substantially fluid-tight seal.

The provision of a lubricant in the sheath is found to considerably increase the lifetime of the inlet and outlet leads, termed “flying leads” in this art. Typically the sheath is sealed at its end adjacent to the column with a fluid-tight seal in order to reduce or avoid the loss of lubricant as a consequence of centrifugal force during use of the apparatus.

The column is preferably helical or spiral, typically comprising one or more helix or spiral tubing. Preferably the leads are tubular. Preferably the inlet and outlet conduits are tubular. Preferably the conduits pass along the cantilever shaft. Preferably the shaft has an axial bore and the inlet and outlet conduits, e.g. tubular conduits, pass along the axial bore of the shaft. The end of the sheath adjacent to the shaft may, for example, engage with an open end of such an axial bore. In such a construction, connection between the inlet and outlet leads and the inlet and outlet conduits may be made within the axial bore, and most conveniently the same are located adjacent to the open end of the bore to which the sheath engages.

Preferably both the inlet and outlet leads are enclosed within the sheath. Preferably the tubular sheath is also sealed at its end adjacent to the shaft with a fluid-tight seal. The tubular sheath may be made of any convenient material, such as a plastics material or a metal.

In one embodiment the fluid-tight seals may be a plug- or grommet-type seal through which the inlet and outlet leads pass in a fluid-tight manner.

Typically the lubricant is a fluid, e.g. a liquid or grease. Suitably at least 50% of the internal volume of the sheath may be filled with the lubricant.

In one embodiment the sheath is designed so as to retain a substantially semi-circular shape when the centrifuge is in use. For example, this may be achieved by using suitable dimensions of the sheath such that the sheath is more rigid at its end closest to the shaft than at its end closer to the column. This may be achieved by making the end closest to the shaft of greater cross-sectional diameter. With such dimensions, when the column is rotated around the shaft and is therefore producing an outward radial force on the flying lead section, the greater stiffness of the end of the sheath closest to the shaft relative to the end of the sheath which is closer to the column, allows only partial deformation of the sheath such as to produce the semi-circular shape.

In one embodiment a first end of the said leads is constrained from moving in rotational and/or linear directions.

In one embodiment the said first end of the inlet and outlet leads is fully constrained in terms of movement whilst, at the opposing second end of the leads, the same are constrained to prevent rotation of the same but are free to move in a linear manner, typically along the longitudinal axis of the flying lead sheath.

Typically the said first end is located adjacent the column and the said second end is adjacent the shaft. Typically the first end is sealed entirely to prevent leakage of the lubricant from that end which particularly experiences high centripetal accelerations.

In a further aspect of the invention there is provided centrifuge apparatus, said apparatus including a shaft, at least one column mounted on the shaft, the column having an inlet and an outlet connective to respective inlet and outlet leads for communication to respective inlet and outlet means wherein a first end of the said leads are constrained from moving in linear and/or rotational directions.

In one embodiment the said leads are constrained from moving in both linear and rotational directions at a first end. Typically, in this arrangement the opposing second end of the leads is able to move in a substantially linear direction. Yet further, the said second ends of the leads are constrained from moving in a rotational direction.

In a further aspect of the invention there is provided a unit, said unit including inlet and outlet leads and a sheath through which the same pass and are enclosed thereby, said unit provided to be connected to centrifuge apparatus at opposing ends of the sheath and wherein said sheath includes therein a lubricant, said sheath sealed at said opposing ends to retain the lubricant within said sheath.

In one embodiment the unit comprises tubular inlet and outlet leads with end connections for connection to the column and for connection to liquid input and outlet means of a centrifuge apparatus for counter-current chromatography, wherein the inlet and/or outlet leads are enclosed within a tubular sheath having an end for positioning adjacent the column and an end for positioning adjacent the cantilever shaft, the sheath being sealed at least at its end for positioning adjacent the column with a fluid-tight seal, and said sheath containing a lubricant.

In one embodiment the sheath is sealed at both its end for positioning adjacent the column, and at its end for positioning adjacent the shaft, with a fluid-tight seal at each of said ends.

Suitable and preferred aspects of the leads, conduits, connections, sheath, seals and lubricant are as disclosed herein.

In one embodiment the connections e.g. between the sheath and bore, between the leads and the column, and between the leads and the conduits, may be conventional tubing connections, such as screw compression fittings.

In one embodiment, the planetary rotation which is created comprises simultaneous rotation of the column about an axis being the centre of the helix or spiral shape of the column and orbital rotation of the entire column around the shaft.

In one embodiment, a drive rotor is rotatably mounted on the shaft, and rotatably mounted on the drive rotor is at least one planetary shaft supporting the column. In one embodiment two columns are rotatably mounted on planetary shafts diametrically opposite each other relative to the axis of rotation of the drive rotor, thereby achieving balance. The column(s) may be driven in planetary rotation by conventional means such as engagement of circumferential gear teeth on the shaft with circumferential gear teeth on the planetary shaft, or for example a drive belt.

In one embodiment, the centrifuge apparatus may incorporate a drive motor to drive the drive rotor, for example by means of a drive belt or other suitable drive means.

The centrifuge apparatus may include attachment means to removeably attach the column to the drive rotor component, thereby enabling removal of the bobbin from the drive rotor without removal or dismantling of the drive rotor.

The embodiments described herein have the objective of a centrifuge apparatus which can perform separation in minutes, whilst having no or very limited back pressure build-up, and good resolution of substances being separated. Considerations are to maintain stationary phase retention while reducing column volume by shortening the column length but maintaining a higher linear velocity by increasing the speed of rotation of the column to allow the mobile phase flow rate to be increased. In effect, this has been achieved by increasing the speed of rotation of the column(s), the higher “g” fields produced during operation of the apparatus giving better retention of the stationary phase and hence allowing a significant increase in flow without loss of retention. Furthermore, the preferred embodiments provide a smaller rotor which gives more mixing and settling steps per minute, leading to even better mass transfer between the phases and hence resolution.

An additional benefit found in the embodiments described herein is that column and flying lead back pressure can be significantly reduced.

In tests of an embodiment of the present invention, a column capacity of 25 ml with 0.8 mm internal diameter column tubing was used. It is possible to maintain a flow rate of 2 to 4 ml per minute, thereby achieving separation in 6 to 12 minutes and it is believed to be feasible to scale up the centrifuge to production scale. Testing has identified a five times increase in the service life of the flying leads which decreases the routine maintenance which is required to be performed and increases the reliability of the apparatus.

The use of a drive rotor mounted in cantilever fashion on a cantilever shaft enables all of the components of the centrifuge to be mounted on the rotor and provide substantially reduced mechanical complexity. It also allows the use of specific design features, such as the flying lead configuration, the bobbin configuration and also an enclosed gear box arrangement. It also allows the use of different types of coil column structures.

Typically, the arrangement of a flying lead section in the manner disclosed herein in which one end of the leads is constrained to prevent rotational and linear movement, whilst the other ends of the leads are at least allowed to move in a linear manner, minimises the possibility of lubricant leakage from the sheath, maintains the leads in the required configuration and reduces to a minimum the number of tortuous paths required to be taken by fluid exiting the column and hence avoids corruption of the chromatography results. Furthermore, it substantially reduces back pressure and enables the accommodation of back pressure from detection equipment attached to the outlet lead.

In particular the provision of a sheath enclosing the inlet and outlet leads and containing a lubricant is found to substantially reduce wear and tear of the leads and therefore to substantially increase both the reliability of this component and to increase the time between necessary maintenance or replacement intervals.

The invention will be described by reference to the accompanying drawings wherein;

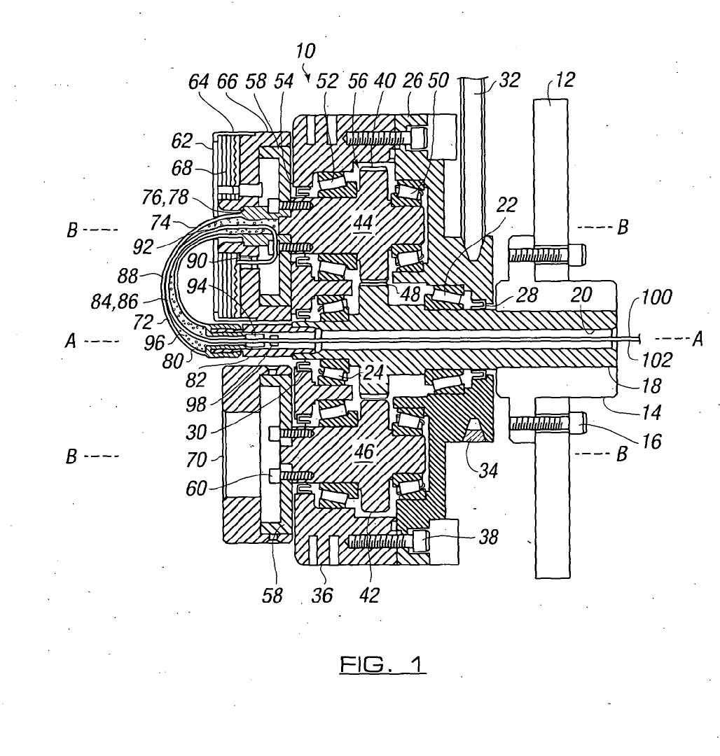

FIG. 1 shows a schematic diagram in cross section of a counter-current chromatography apparatus in accordance with one embodiment of the invention; and

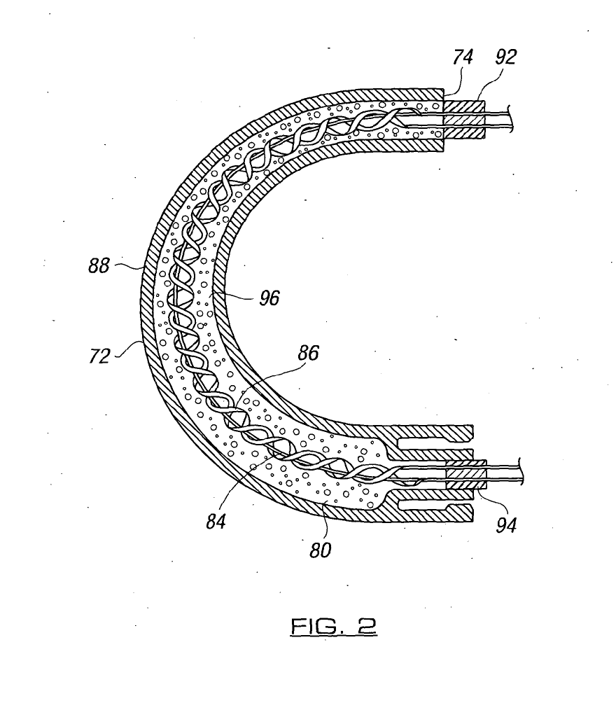

FIG. 2 illustrates a unit incorporating flying leads and a sheath in accordance with one embodiment of the invention.

Referring now to FIG. 1, this shows a centrifuge apparatus 10 (generally) for counter current chromatography. The centrifuge apparatus 10 is intended to be rotated at high speeds, for example in excess of 2000 rpm. The size of column and rotational speeds can be chosen on the basis of the desired application. The centrifuge apparatus 10 is typically kept in a casing (not shown) for protection purposes and for allowing control of environmental conditions such as temperature. Furthermore, in addition to the components shown in FIG. 1, the centrifuge apparatus 10 is provided with the other elements typical in apparatus of this type, such as power supplies, control systems, fluid input and output systems such as pumps, reservoirs etc., in a manner apparent to those skilled in the art.

The centrifuge apparatus 10 is mounted on a support wall 12, in practice integral with the casing, to which is attached a mounting bush 14 by bolts or other suitable fastening means 16. The mounting bush in this embodiment holds a cantilever shaft 18 non rotatably relative to support wall 12. The shaft 18 has an axial bore 20.

Rotatably mounted on the cantilever shaft 18 is a drive rotor 26. First and second sets of radial taper roller bearings 22, 24 facilitate rotation of the drive rotor about first axis A-A, being the axis of shaft 18. First and second radial seals 28, 30 are provided to protect the bearings 22, 24 and contain lubricating oil. A drive belt 32 is provided which drives a corresponding pulley 34 of the drive rotor 26 in a conventional manner. At a frontal portion of the drive rotor 26 is provided a set of cooling fins 36 extending into the drive rotor 26. It will be seen from FIG. 1 that the drive rotor 26 is formed in two parts secured together by bolts or other suitable fastening means 38.

Rotatably mounted on drive rotor 26 are two planetary shafts 44, 46 disposed diametrically opposite each other across first axis A-A. These planetary shafts 44, 46 are mounted for rotation about second axes B-B diametrically opposite each other relative to axis A-A. On the planetary shaft 44 are circumferential gear teeth 40, and on cantilever shaft 18 are circumferential gear teeth 48. Gears 40 engage with gear teeth 48 so that when drive rotor 26 rotates on cantilever shaft 18 the planetary shaft 44 is driven in rotation, facilitated by sets of bearings 50, 52. A seal 54 seals the gear set 40 in such a manner as to provide a chamber 56 within which the first gear set 40 and within which the planetary shaft 44 and bearings 50, 52 are located. This chamber 56 is at least partially filled with lubricant such as oil or grease. As can be seen in FIG. 1, the frontal bearings 52 are larger than the rear bearings 50 since the bearings 52 will take the load of the bobbin 62 or counter-weight 70. Planetary shaft 46 is not driven by the shaft 18 in rotation because planetary shaft 45 supports counter-weight 70. However in an alternative embodiment a second bobbin (not shown) could be mounted on shaft the arrangement of planetary shaft 46 and its gears 42 could be the same as planetary shaft 44.

Planetary shaft 44 is provided with a bobbin mounting 58 fixed thereto by bolts or other suitable fastening means 60. Planetary shaft 46 is also provided with a bobbin mounting 58 to which is fixed counterweight 70.

To bobbin mounting 58 on the shaft 44 is attached a bobbin 62 formed of a column housing 64 having an annular flange which fits around the outer perimeter of the mounting 58 and which includes a plurality of bores (in this case four) for receiving fixing bolts 66. In this manner, the bobbin is fixed to the mounting 58 and thus rotates with the rotatable shaft 44. It is envisaged that the bolts 66 could be replaced by a quick release coupling mechanism to allow for fast changing of the bobbin 62, for the purposes described herein. Similarly, a quick release mechanism could also replace bolts that hold mounting 58 to the shaft 44. The bobbin housing 64 holds a helical coil of tubing 68 forming a column. The counter weight 70 provides a balancing weight diametrically opposite to bobbin 58 and its column 68.

As can be seen in FIG. 1, the bobbin 62 is open at its centre, providing for the placement of an inlet and outer lead section or unit, hereinafter referred to as a flying lead section 72 passing through the middle of the column 68. A first end 74 of the flying lead section 72 adjacent to the bobbin 62 and column 68 is held in the bobbin 62 by mutually co-operating shoulders 76, 78. A second end 80 of the flying lead section 72 adjacent to the cantilever shaft 18 is coupled to the cantilever shaft 18 by engagement of the end 80 with an open end of the bore 20 by means of a suitable non-rotatable bush 82, or a continuation of the cantilever shaft 18.

Located in the flying lead section 72, which is shown in more detail in FIG. 2, are inlet and outlet leads 84, 86, so called “flying leads” in the form of tubular conduits. One end of each flying lead 84, 86 is coupled to the column 68 by a suitable coupling 90 (only one coupling 90 being visible in FIG. 1).

The flying lead section 72 is in the form of a sheath 88 of elastomeric material enclosing the inlet and outlet leads 84, 86. The leads 84, 86 are twisted around each other in this embodiment so as to follow substantially the same path when the apparatus is in use. Where more than two leads 84, 86 are provided (for example if there is also a column on the shaft 46) these may be braided. The dimensions of the sheath 88 are such that it is more rigid at its end 80 relative to its end 74 by making the end 80 of greater cross-sectional diameter. Consequently when the bobbin 62 rotates, producing an outward radial force on the flying lead section 72, the greater stiffness of the end 80 relative to the end 74 allows only partial deformation of the sheath 88, designed to be such as to produce the semi-circular shape. Suitable forms of the sheath can be determined readily by experimentation or calculation.

The sheath 88 is closed at its end adjacent to the column 68 by a fluid-tight seal 92, and is also closed at its end adjacent to the axial bore 20 by a second fluid-tight seal 94. The inlet and outlet leads 84, 86 pass through seals 92,94 in a fluid-tight manner. The interior of sheath 88 is substantially filled with a viscous grease lubricant 96. Inlet and outlet conduits 100, 102 are provided to connect the centrifuge apparatus 10 via leads 84,86 to respective inlet and outlet means (not shown), and one end of each lead 84, 86 is coupled to the inlet and outlet conduits 100, 102 by a suitable coupling 98 (only one coupling 98 being visible in FIG. 1). The coupling connection between the leads 84, 86 and the conduits 100, 102 conveniently occurs within the axial bore 20.

The flying lead section 72 is designed such that during rotation of the rotor 26 the sheath 88 adopts a substantially semi-circular shape, achieved by making the end 80 thicker than the end 74. This profile minimises potential blockage and disturbance of fluid passing through the outlet lead 86. The seals 92, 94 prevent loss of the lubricant 96 during rotation of the drive rotor 26, especially loss that might otherwise result from the considerable centrifugal forces the lubricant 96 is subjected to.

Preferably in addition, or possibly, without, the sealing of the ends of the sheath to maintain the lubricant within the same, the coupling means between the ends of the sheath and the centrifuge apparatus 10 allows the constraint, i.e. prevention of movement of ends of the leads 84,86. In this embodiment the said leads are constrained at the first end 74 from moving in linear and rotational directions and effectively are constrained from moving, typically by the engagement of the sealing means 92 therewith. Typically the leads 84, 86 at the opposing second end 80 are able to move in a substantially linear direction but are constrained from moving in a rotational direction and again this constraint is typically achieved via the sealing means 94. This constrain of movement is found to increase the ability to retain the lubricant within the sheath 88.

In one experimental embodiment, the centrifuge was provided with the driven planetary shaft 44 rotated about a 50 mm radius up to a maximum speed of 2,100 rpm. The column 68 had a beta value range of 0.68 to 0.79, a volume of 4.6 ml using 0.76 mm bore tubing 10.15 metres long. The column 68 was connected to a single pair of 0.5 mm bore PTFE inlet and outlet leads 84, 86 enclosed within the sheath 88 of the flying lead section 72 in a simple 180° turn aligned with the “g” field produced on rotation of the rotor 26 and consequentially induced rotation of the planetary shaft 44. This arrangement, with a mobile flow rate of up to 2 ml/min could achieve separation in 3 to 20 minutes.

In use, the drive rotor 26 is rotated by the drive belt 32. The rotor 26 rotates around shaft 18 on the roller bearings 22, 24. Engagement of the gear teeth 48 of the shaft 18 with teeth 20 of the planetary shaft 44 causes rotation of this shaft 44 about axis B-B and orbital rotation about the axis A-A of cantilevered shaft 18. This rotation of the shaft 44 causes an equivalent rotation of the bobbin 62 and hence of the column 68. The counter weight 70 balances the load of the bobbin 62 so as to ensure that the rotor 26 is substantially balanced.

A first liquid stationary phase (not shown) is introduced into column 68 via inlet conduit 100 connected to the inlet lead 84, and is then distributed around column 68 by rotation as described. A mixture to be subjected to chromatography is then fed in through inlet lead 84 with a pumped mobile solvent phase passing through the axial bore 20 of cantilevered shaft 18, through the flying lead section 72 and therefrom into the inlet of column 68. External pumping action causes this fluid to pass through column 68 and thereby to undergo sequential mixing and settling with the stationary liquid phase being retained by the centrifugal forces from rotation of column 68 so as to separate as in conventional liquid-liquid chromatography. The mobile phase then passes out through the outlet lead 86 and into outlet conduit 102, carrying substances form the inlet mixture as bolus phases which can be detected and isolated.

Heat is generated during use of the centrifuge and in particular at the bearings 52 at the frontal end of the shaft 44, caused by the load of bobbin 62. This heat is effectively managed by the provision of lubricant in the chamber 56 which is retained at a level sufficient to contact and at least partially cover the bearings 52. Heat is thus transferred from the bearings 52 into the lubricant and therefrom into the casing of the rotor 26. The cooling fins 36 in the rotor casing 26 assist in expelling heat from the rotor 26.

As will be apparent from FIG. 1, the cooling fins 36 are located at a distance from the front face of the rotor 26 and thus at a certain distance from the bobbin 62. In this manner, heat is in effect directed away from the bobbin 62 and away from the fluid being centrifuged within the columns 68, thus having a stabilising effect on the fluid temperature. The feature of enclosing the gear sets 40, 42 within the rotor 26 substantially reduces the noise of the instrument. Further, provision of such a closed chamber for the lubricant ensures efficient use of lubricant and thus more reliable operation of the rotor shaft 44 and also avoids the splattering and loss of lubricant. The level of lubricant within the chamber 56 of the rotor 26 is preferably always maintained sufficient to cover at least partially the bearings 52.

The column assembly 68 is preferably made substantially of transparent or translucent material such that movement of fluid within the column 68 can be seen on looking at the bobbin 62.

A user is also able to replace the bobbin 62 relatively easily, for example to replace the bobbin 62 with a new equivalent bobbin or with a bobbin having a different column 68 structure. In order to achieve this, the user need only withdraw the end 80 of flying lead section 72, which is typically a push fit within the bore 20 of shaft 18, and unscrew the radial screws 66 (four are shown, there may be more or less) to remove the column housing 64 of bobbin 62. The flying lead section 72 can then be fed through the central aperture in the bobbin 62, withdrawing its end 80 and bushing 82 last (these will pass through the central 25 bore of the bobbin 62) for use with a new bobbin, alternatively a new set of leads can be supplied with each new bobbin. A pair of removable connectors 92,94 (for example, screw threaded) are provided to connect the leads 84, 86 to the ends of the column 68. Removable connectors 98 may optionally be provided at the end of the flying lead assembly 72 adjacent to the axial bore 20. A new bobbin is then attached to leads 84, 86 and then attached to the mounting 58 by the fixing bolts 66.

In the preferred embodiment, the bolts 66 are replaced by quick release catches to make replacement of the bobbin 62 even faster.

Thus, the user is able to replace the bobbin 62 with relative ease and need not be required to call out skilled service personnel for this purpose.

It can be seen from the above description that the preferred embodiment provides the least stressful path for the flying lead section 72 and a simple arrangement of the cantilevered rotor 26 driving the single planet shaft 44 with the bobbin 62 mounted on the end of the shaft 44. Furthermore, the ability to see the flying lead section 72 enables an operator to see the state of this section of the leads 84,86 and replace it as and when necessary. The section 72 is completely unsupported and has no surface which touches the bobbin 62 or other component, adding to the durability of section 72. The section 72 in effect provides potting of the inlet and outlet leads 84, 86, reducing back pressure levels compared to prior art machines and also prevents twisting of the leads in a manner which could cause malfunction of the instrument. The lubricant 96 within the sheath 88 reduces wear and tear on the leads 84, 86 and significantly extends the time between maintenance or replacement intervals.

The combination of tubular inlet and outlet leads 84, 86 and end connections 90, 98 enclosed within the tubular sheath 88 sealed at both said ends with the fluid-tight seals 92, 94 and containing the lubricant 96 may be provided separately as a unit as shown in FIG. 2 for connection to the other elements of the centrifuge apparatus 10 which allows easy replacement of the same and also allows other centrifuge apparatus to be adapted by the retrofitting of the unit 72.

1. A centrifuge apparatus, said apparatus comprising:
a shaft on which at least one column is mounted for planetary rotation about the shaft, the at least one column having an inlet and an outlet connected to respective inlet and outlet leads for communication to respective inlet and outlet conduits; and
wherein between the at least one column and the inlet and outlet conduits, the inlet and/outlet leads are at least partially located within a tubular sheath having an end adjacent the column and an end adjacent the shaft, the tubular sheath containing a lubricant therein to allow hydrodynamic lubrication between the inlet and outlet leads and the sheath.

2. Apparatus according to claim 1 wherein the apparatus is for use for counter current chromatography.

3. (canceled)

4. Apparatus according to claim 1 wherein the said inlet and outlet conduits follow the shaft.

5. Apparatus according to claim 1 wherein the inlet and outlet leads are substantially enclosed by the sheath.

6. Apparatus according to claim 1 wherein the sheath is sealed at least at its end adjacent to the column or the end adjacent to the shaft with a substantially fluid-tight seal.

7. Apparatus according to claim 1 wherein the sheath is sealed at its end adjacent to the shaft and the end adjacent to the column with a fluid tight seal.

8. Apparatus according to claim 1 wherein the column is helical or spiral.

9. (canceled)

10. Apparatus according to claim 1 wherein the shaft has an axial bore and the inlet and outlet conduits pass along the axial bore of the shaft and the end of the sheath adjacent to the shaft is engaged with an open end of the axial bore.

11. (canceled)

12. (canceled)

13. (canceled)

14. (canceled)

15. (canceled)

16. Apparatus according to claim 1 wherein the end of the sheath closest to the shaft has a larger cross-sectional area than the end of the sheath closest to the column.

17. Apparatus according to claim 1 wherein at a first end of the inlet and outlet leads the same are constrained from moving in rotational and/or linear directions, said first end located adjacent the column.

18. (canceled)

19. Apparatus according to claim 1 wherein at a second end of the inlet and outlet leads located adjacent to the shaft the same are constrained from moving in a rotational direction and free to move in a linear direction.

20. (canceled)

21. Apparatus according to claim 1 wherein the planetary rotation which is created comprises simultaneous rotation of the column about an axis and orbital rotation of the entire column around the shaft.

22. Apparatus according to claim 1 wherein a drive rotor is rotatably mounted on the shaft, and rotatably mounted on the drive rotor is at least one planetary shaft supporting the column.

23. Apparatus according to claim 22 wherein two columns are rotatably mounted on planetary shafts diametrically opposite each other relative to the axis of rotation of the drive rotor, thereby achieving balance.

24. (canceled)

25. Apparatus according to claim 1 wherein connection of the inlet and outlet leads allows the flow of liquid between the column and inlet and outlet conduits.

26. (canceled)

27. (canceled)

28. (canceled)

29. (canceled)

30. (canceled)

31. A unit, said unit comprising:
inlet and outlet leads and a sheath through which the same pass and are enclosed thereby;
said unit provided to be connected to centrifuge apparatus at opposing ends of the sheath; and
wherein said sheath includes therein a lubricant, said sheath sealed at said opposing ends to retain the lubricant within said sheath.

32. A unit according to claim 31 wherein the inlet and outlet leads are tubular with, at one end connection means to allow connection to a column and at the opposing end, connection means to allow connection to liquid input and outlet conduits of the centrifuge apparatus.
